(19) United States
(12) Patent Application Publication
(10) Pub. No.: US 2012/0072504 A1
(43) Pub. Date: Mar. 22, 2012

(54) DEVICES AND METHODS FOR MANAGING COLLABORATIVE COMMUNICATIONS SESSIONS

(75) Inventor: Frank Kowalewski, Goettingen (DE)

(73) Assignee: Infineon Technologies AG, Neubiberg (DE)

(21) Appl. No.: 12/887,617

(22) Filed: Sep. 22, 2010

(51) Int. Cl. G06F 15/16

(52) U.S. Cl. 709/206

(57) ABSTRACT

In an embodiment, a method for providing information for managing a collaborative communications session may be provided. The method may include generating a first message according to a call control protocol; generating a second message according to the call control protocol, the second message including information for managing the collaborative communications session; and sending the first message to a call managing server. The first message may be generated to include the second message.

### TECHNICAL FIELD

Various embodiments relate generally to methods for providing information for managing a collaborative communications session, methods for managing a collaborative communications session, end devices and call managing servers.

### BACKGROUND

Collaborative communications sessions may be held in various kinds of networks. A collaborative session may be a peer's communications session that includes multiple communication devices. In other words the communication peer may be using multiple communication devices to communicate with other peers. One or several of the devices may be controlling the collaborative session. Those controller devices may be able to direct media (e.g. audio, video, text, etc.) to the collaborative session's devices.

In commonly used methods, the Session Description Protocol (SDP) may not specify SIP addresses for connections. Therefore the other devices may not be specified by SDP to become part of the collaborative session if only their SIP addresses are known by the initiating device.

In commonly used methods, in IMS (IP (Internet Protocol) Multimedia Subsystem) collaborative sessions, it may be disadvantageous that collaborative sessions cannot be established if the device wanting to establish the collaborative session is not yet in a communications session with the remote device.

In commonly used methods, when establishing a collaborative session during communications initiation by including SDP for controllee devices (in other words: for controlled devices), it may be a disadvantage that controllee devices cannot be specified if only their SIP addresses are known by the device wanting to establish the collaborative session.

In commonly used methods, when using an SDP extension for specifying SIP addresses in SDP, it may be disadvantageous that the extension is not part of a standard.

In commonly used methods, when using an SDP extension for specifying SIP addresses in SDP, it may also be disadvantageous that application layer SIP addresses would have to be specified in SDP c-lines reserved for transport layer addresses.

In commonly used methods, when using the SDP extension for specifying SIP addresses in SDP it may also be disadvantageous that the SDP implementation being used must be extended compared to existing SDP implementations.

In commonly used methods, when establishing a collaborative session during communications initiation by including SDP for controllee devices, it may also be disadvantageous that multiple controller devices cannot be specified.

According to commonly used methods, a prerequisite for media transfer may be that the media transfer requesting device already has a communications session with the other peer's (remote) device. Therefore devices not yet in a communications session with the remote device may not establish collaborative sessions through media transfer.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows various communication devices in accordance with an embodiment;

FIG. 2 shows a flow diagram illustrating a method for providing information for managing a collaborative communications session in accordance with an embodiment;

FIG. 3 shows a flow diagram illustrating a method for managing a collaborative communications session in accordance with an embodiment;

FIG. 4 shows an end device in accordance with an embodiment;

FIG. 5 shows a call managing server in accordance with an embodiment;

FIG. 6 shows a flow diagram illustrating a method for providing information for managing a collaborative communications session in accordance with an embodiment;

FIG. 7 shows a signaling flow diagram illustrating a signaling flow in accordance with an embodiment;

FIG. 8 shows a signaling flow diagram illustrating a signaling flow in accordance with an embodiment;

FIG. 9 shows a signaling flow diagram illustrating a signaling flow in accordance with an embodiment;

FIG. 10 shows a signaling flow diagram illustrating a signaling flow in accordance with an embodiment; and

FIG. 11 shows a flow diagram illustrating a method for managing a collaborative communications session.

### DESCRIPTION

The following detailed description refers to the accompanying drawings that show, by way of illustration, specific details and embodiments in which the invention may be practiced. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any embodiment or design described herein as “exemplary” is not necessarily to be construed as preferred or advantageous over other embodiments or designs.

An end device according to various embodiments may be a device configured for wired communication, for example a desktop computer or laptop, or for wireless communication, for example a radio communication device. In various embodiments, a radio communication device may be an end-user mobile device (MD). In various embodiments, a radio communication device may be any kind of mobile radio communication device, mobile telephone, personal digital assistant, mobile computer, or any other mobile device configured for communication with a mobile communication base station (BS) or an access point (AP) and may be also referred to as a User Equipment (UE), a mobile station (MS) or an advanced mobile station (advanced MS, AMS), for example in accordance with IEEE 802.16m.

The end device may include a memory which may for example be used in the processing carried out by the end device. The call managing server may include a memory which is for example used in the processing carried out by the call managing server. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Various embodiments are provided for devices, and various embodiments are provided for methods. It will be understood that basic properties of the devices also hold for the methods and vice versa. Therefore, for sake of brevity, duplicate description of such properties may be omitted.

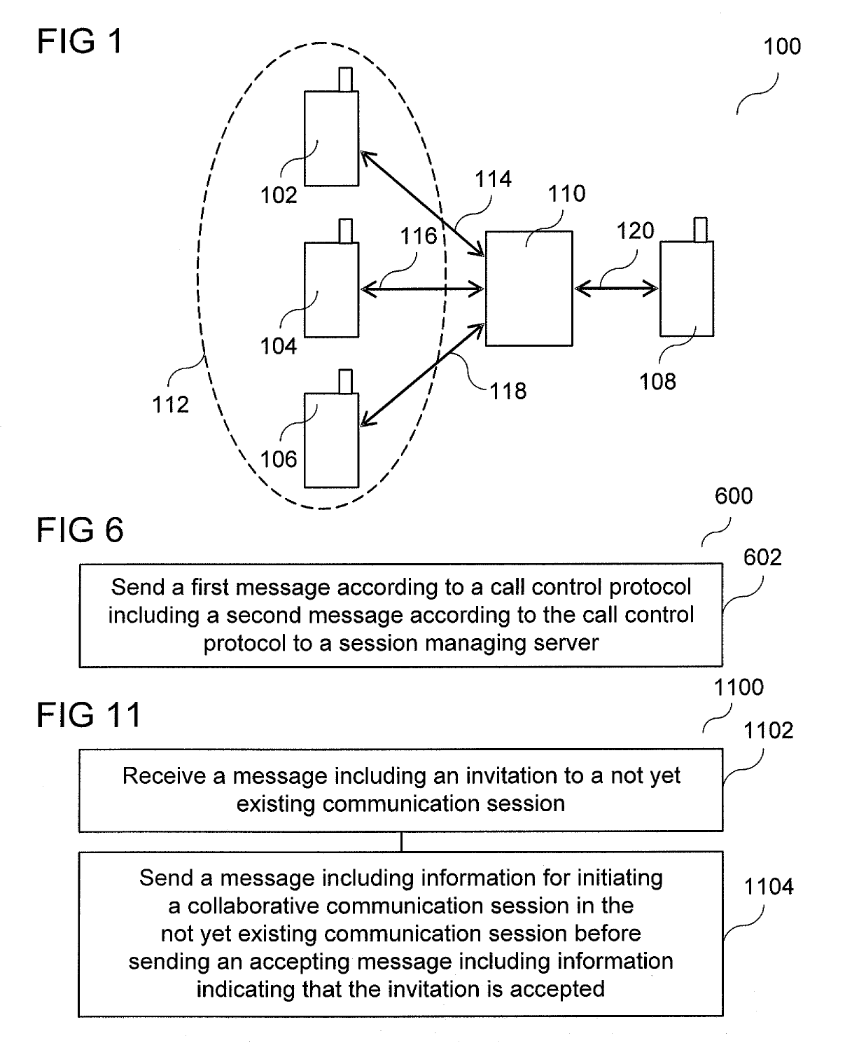

FIG. 1 shows various communication devices in accordance with an embodiment. In the arrangement 100, a first end device 102 (which may also be referred to as T1), a second end device 104 (which may also be referred to as T2), a third end device 106 (which may also be referred to as T3), a fourth end device 108 (which may also be referred to as T4), and a call managing server 110 (which may also be referred to as S) may be provided. Each of the end devices may belong to a user, and a user may have more than one end device. For example, the first end device 102, the second end device 104, and the third end device 106 may belong to a first user (who may also be referred to as U1), like indicated by dashed ellipse 112. The fourth end device 108 may belong to a second user (who may also be referred to as U2). The first end device 102 may communicate with the call managing server 110, for example via a wired connection or a wireless connection, like indicated by a first arrow 114. The second end device 104 may communicate with the call managing server 110, for example via a wired connection or a wireless connection, like indicated by a second arrow 116. The third end device 106 may communicate with the call managing server 110, for example via a wired connection or a wireless connection, like indicated by a third arrow 118. The fourth end device 108 may communicate with the call managing server 110, for example via a wired connection or a wireless connection, like indicated by a fourth arrow 120.

For example, the arrangement 100 may illustrate a simplified architecture of an IMS (IP (Internet Protocol) Multimedia Subsystem) based communications system, wherein the call managing server 110 may be a IMS server, like will be explained in more detail below.

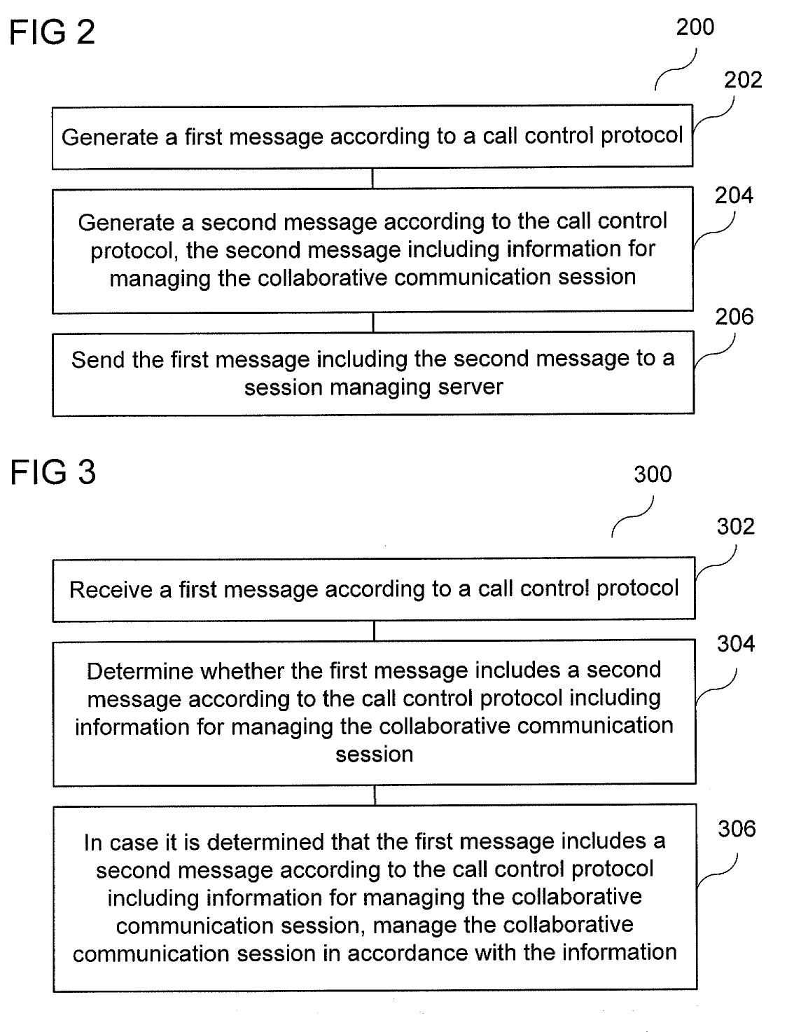

FIG. 2 shows a flow diagram 200 illustrating a method for providing information for managing a collaborative communications session in accordance with an embodiment. In 202, a first message may be generated according to a call control protocol. In 204, a second message may be generated according to the call control protocol. The second message may include information for managing the collaborative communications session. The first message may be generated to include the second message. In 206, the first message may be sent to a call managing server.

The call control protocol may also be referred to as session control protocol or as telecommunication conference control protocol.

According to various embodiments, the first message may include a plurality of second messages.

According to various embodiments, the call control protocol may include or may be at least one of Session Initiation Protocol SIP, Real-Time Control Protocol RTCP, Hyper Text Transport Protocol http, File Transfer Protocol FTP, Simple Mail Transfer Protocol SMTP, and XML Configuration Access Protocol XCAP.

According to various embodiments, the second message may include information for changing an existing communication session.

According to various embodiments, the second message may include information for initiating a collaborative communications session from an existing communication session. In other words: The second message may include information for changing an existing communication session, which is not a collaborative communications session yet, into a collaborative communications session.

According to various embodiments, the second message may include information for initiating a collaborative communications session in a not yet existing communication session.

According to various embodiments, the second message may be a SIP REFER message. According to various embodiments, the second message may be a SIP INFO message.

According to various embodiments, the second message may include information for transferring media from a first end device to a second end device.

According to various embodiments, the first end device and the second end device may belong to the same user.

According to various embodiments, the first message may be generated in the first end device.

According to various embodiments, the call control protocol may be a Session Initiation Protocol SIP and the second message may be a SIP REFER message.

According to various embodiments, the first message may include information for managing a communication session.

According to various embodiments, the first message may include information for setting up a communication session.

According to various embodiments, the call control protocol may be a Session Initiation Protocol SIP, and the second message may be a SIP INVITE message or a SIP OK message.

According to various embodiments, a call identifier of the first message and a call identifier of the second message may be the same. This may allow the call managing server to determine that the first message and the second message included in the first message are related to the same call, or to the same session.

According to various embodiments, the call control protocol may be a Session Initiation Protocol SIP, and a value of Call-ID of the first message and a value of Call-ID of the second message may be the same.

FIG. 3 shows a flow diagram 300 illustrating a method for managing a collaborative communications session in accordance with an embodiment. In 302, a first message may be received according to a call control protocol. In 304, it may be determined whether the first message includes a second message according to the call control protocol including information for managing the collaborative communications session. In 306, in case it is determined that the first message includes a second message according to the call control protocol including information for managing the collaborative communications session, the collaborative communications session may be managed in accordance with the information.

According to various embodiments, in case it is determined that the first message does not include a second message according to the call control protocol including information for managing the collaborative communications session, the collaborative communications session may not be changed, or, in case a collaborative communications session does not yet exist, may not be established.

According to various embodiments, the first message may include a plurality of second messages.

According to various embodiments, the first message may be received in a call managing server. According to various embodiments, the first message may be generated by an end device. According to various embodiments, the first message may be sent by an end device.

According to various embodiments, the call control protocol may include or may be at least one of Session Initiation Protocol SIP, Real-Time Control Protocol RTCP, Hyper Text Transport Protocol http, File Transfer Protocol FTP, Simple Mail Transfer Protocol SMTP, and XML Configuration Access Protocol XCAP.

According to various embodiments, the second message may include information for changing an existing communication session.

According to various embodiments, the first message may be received in a call managing server and the call managing server may change an existing communication session in accordance with the information included in the second message.

According to various embodiments, the second message may include information for initiating a collaborative communications session from an existing communication session. In other words: The second message may include information for changing an existing communication session, which is not a collaborative communications session yet, into a collaborative communications session.

According to various embodiments, the second message may include information for initiating a collaborative communications session in a not yet existing communication session.

According to various embodiments, the second message may be a SIP REFER message. According to various embodiments, the second message may be a SIP INFO message.

According to various embodiments, the first message may be received in a call managing server, and the call managing server may initiate a collaborative communications session from an existing communication session in accordance with the information included in the second message.

According to various embodiments, the second message may include information for transferring media from a first end device to a second end device.

According to various embodiments, the first message may be received in a call managing server, and the call managing server may transfer media from the first end device to the second end device in accordance with the information included in the second message.

According to various embodiments, the first end device may be the sender of the first message.

According to various embodiments, the first end device and the second end device may belong to the same user.

According to various embodiments, the call control protocol may be a Session Initiation Protocol SIP, and wherein the second message may be a SIP REFER message.

According to various embodiments, the first message may include information for managing a communication session.

According to various embodiments, the first message may be received in a call managing server, and the call managing server may manage a communication session in accordance with the information included in the first message.

According to various embodiments, the first message may include information for setting up a communication session.

According to various embodiments, the first message may be received in a call managing server, and the call managing server may set up a communication session in accordance with the information included in the first message.

According to various embodiments, the call control protocol may be a Session Initiation Protocol SIP, and the second message may be a SIP INVITE message or a SIP OK message.

According to various embodiments, a call identifier of the first message and a call identifier of the second message may be the same. This may allow the call managing server to determine that the first message and the second message included in the first message are related to the same call, or to the same session.

According to various embodiments, the call control protocol may be a Session Initiation Protocol SIP, and a value of Call-ID of the first message and a value of Call-ID of the second message may be the same.

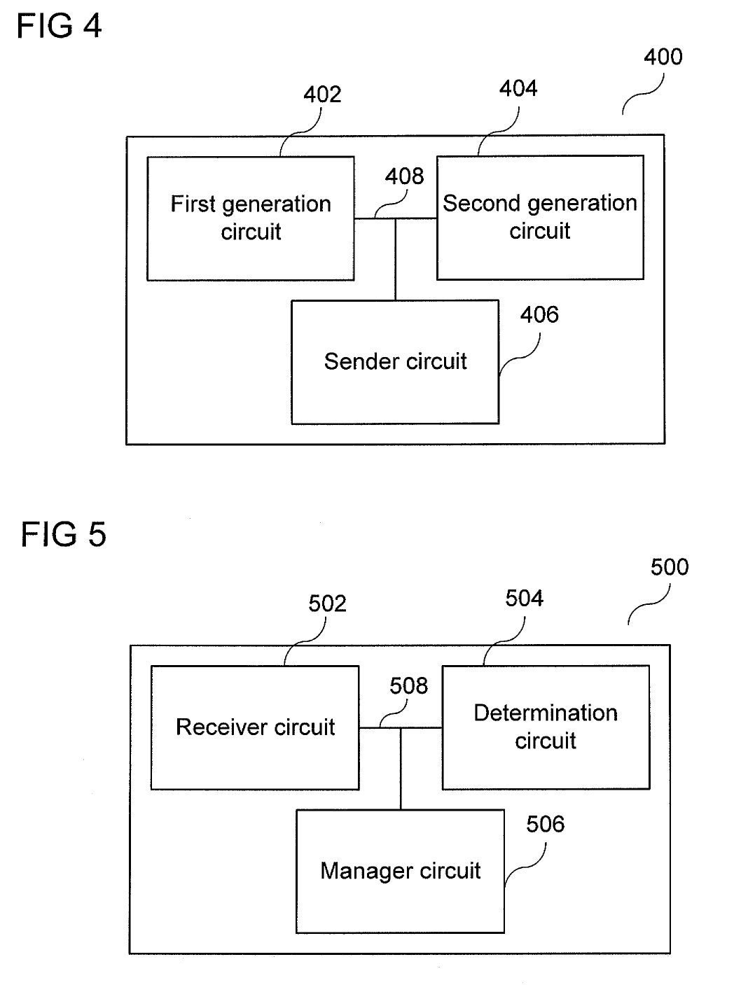

FIG. 4 shows an end device 400 in accordance with an embodiment. The end device 400 may be an end device for providing information for managing a collaborative communications session. The end device 400 may include a first generation circuit 402 configured to generate a first message according to a call control protocol; a second generation circuit 404 configured to generate a second message according to the call control protocol; and a sender circuit 406 configured to send the first message to a call managing server. The second message may include information for managing the collaborative communications session. The first generation circuit 402 may be configured to generate the first message to include the second message. The first generation circuit 402, the second generation circuit 404, and the sender circuit 406 may be coupled with each other, e.g. via an electrical connection 408 such as e.g. a cable or a computer bus or via any other suitable electrical connection to exchange electrical signals.

According to various embodiments, the first message may include a plurality of second messages.

According to various embodiments, the call control protocol may include or may be at least one of Session Initiation Protocol SIP, Real-Time Control Protocol RTCP, Hyper Text Transport Protocol http, File Transfer Protocol FTP, Simple Mail Transfer Protocol SMTP, and XML Configuration Access Protocol XCAP.

According to various embodiments, the second generation circuit 404 may be configured to generate the second message including information for changing an existing communication session.

According to various embodiments, the second generation circuit 404 may be configured to generate the second message including information for initiating a collaborative communications session from an existing communication session. For example, the second message may include information for changing an existing communication session, which is not a collaborative communications session yet, into a collaborative communications session.

According to various embodiments, the second generation circuit 404 may further be configured to generate the second message comprising information for initiating a collaborative communications session in a not yet existing communication session.

According to various embodiments, the second generation circuit 404 may further be configured to generate the second message as a SIP REFER message. According to various embodiments, the second generation circuit 404 may further be configured to generate the second message as a SIP INFO message.

According to various embodiments, the second generation circuit 404 may be configured to generate the second message including information for transferring media from a first end device to a second end device.

According to various embodiments, the first end device and the second end device may belong to the same user.

According to various embodiments, the call control protocol may be a Session Initiation Protocol SIP, and the second generation circuit 404 may be configured to generate the second message as a SIP REFER message.

According to various embodiments, the first generation circuit 402 may be configured to generate the first message including information for managing a communication session, for example for managing a collaborative communications session.

According to various embodiments, the first generation circuit 402 may be configured to generate the first message including information for setting up a communication session.

According to various embodiments, the call control protocol may be a Session Initiation Protocol SIP, and the second generation circuit 404 may be configured to generate the second message as a SIP INVITE message or a SIP OK message.

According to various embodiments, the first generation circuit 402 and the second generation circuit 404 may be configured to generate the first message and the second message with a call identifier of the first message and a call identifier of the second message being the same. This may allow the call managing server to determine that the first message and the second message included in the first message are related to the same call, or to the same session.

According to various embodiments, the call control protocol may be a Session Initiation Protocol SIP, and the first generation circuit 402 and the second generation circuit 404 may be configured to generate the first message and the second message with a value of Call-ID of the first message and a value of Call-ID of the second message being the same.

FIG. 5 shows a call managing server 500 in accordance with an embodiment. The call managing server 500 may be a call managing server for managing a collaborative communications session. The call managing server 500 may include a receiver circuit 502 configured to receive a first message according to a call control protocol; a determination circuit 504 configured to determine whether the first message includes a second message according to the call control protocol including information for managing the collaborative communications session; and a manager circuit 506 configured to, in case the determination circuit 504 determines that the first message includes a second message according to the call control protocol including information for managing the collaborative communications session, manage the collaborative communications session in accordance with the information. The receiver circuit 502, the determination circuit 504, and the manager circuit 506 may be coupled with each other, e.g. via an electrical connection 508 such as e.g. a cable or a computer bus or via any other suitable electrical connection to exchange electrical signals.

According to various embodiments, in case it is determined that the first message does not include a second message according to the call control protocol including information for managing the collaborative communications session, the collaborative communications session may not be changed, or, in case a collaborative communications session does not yet exist, may not be established.

According to various embodiments, the first message may include a plurality of second messages.

According to various embodiments, the first message may be sent from an end device.

According to various embodiments, the call control protocol may include or may be at least one of Session Initiation Protocol SIP, Real-Time Control Protocol RTCP, Hyper Text Transport Protocol http, File Transfer Protocol FTP, Simple Mail Transfer Protocol SMTP, and XML Configuration Access Protocol XCAP.

According to various embodiments, the second message may include information for changing an existing communication session.

According to various embodiments, the call managing server 500 may be configured to change an existing communication session in accordance with the information included in the second message.

According to various embodiments, the second message may include information for initiating a collaborative communications session from an existing communication session. For example, the second message may include information for changing an existing communication session, which is not a collaborative communications session yet, into a collaborative communications session.

According to various embodiments, the second message may include information for initiating a collaborative communications session in a not yet existing communication session.

According to various embodiments, the second message may be a SIP REFER message. According to various embodiments, the second message may be a SIP INFO message.

According to various embodiments, the call managing server 500 may be configured to initiate a collaborative communications session from an existing communication session in accordance with the information included in the second message.

According to various embodiments, the second message may include information for transferring media from a first end device to a second end device.

According to various embodiments, the call managing server 500 may be configured to transfer media from the first end device to the second end device in accordance with the information included in the second message.

According to various embodiments, the first end device and the second end device may belong to the same user.

According to various embodiments, the first message may be sent from the first end device.

According to various embodiments, the call control protocol may be a Session Initiation Protocol SIP, and the second message may be a SIP REFER message.

According to various embodiments, the first message may include information for managing a communication session, for example for managing a collaborative communications session.

According to various embodiments, the call managing server 500 may be configured to manage a communication session in accordance with the information included in the first message.

According to various embodiments, the first message may include information for setting up a communication session.

According to various embodiments, the call managing server 500 may be configured to set up a communication session in accordance with the information included in the first message.

According to various embodiments, the call control protocol may be a Session Initiation Protocol SIP, and the second message may be a SIP INVITE message or a SIP OK message.

According to various embodiments, a call identifier of the first message and a call identifier of the second message may be the same. This may allow the call managing server 500 to determine that the first message and the second message included in the first message are related to the same call, or to the same session.

According to various embodiments, the call control protocol may be a Session Initiation Protocol SIP, and a value of Call-ID of the first message and a value of Call-ID of the second message may be the same.

FIG. 6 shows a flow diagram 600 illustrating a method for providing information for managing a collaborative communications session in accordance with an embodiment. In 602, a first message may be sent according to a call control protocol including a second message according to the call control protocol to a call managing server. The second message may include information for managing the collaborative communications session.

According to various embodiments, a method for managing a collaborative communications session may be provided. The method may include, in case it is determined that a received first message according to a call protocol includes a second message according to the call control protocol including information for managing the collaborative communications session, managing the collaborative communications session in accordance with the information.

According to various embodiments, an end device for providing information for managing a collaborative communications session may be provided. The end device may include a sending circuit configured to send a first message according to a call control protocol including a second message according to the call control protocol to a call managing server. The second message may include information for managing the collaborative communications session.

According to various embodiments, a call managing server may be provided. The call managing server may be a call managing server for managing a collaborative communications session. The call managing server may include a manager circuit configured to, in case it is determined that a received first message according to a call protocol includes a second message according to the call control protocol including information for managing the collaborative communications session, manage the collaborative communications session in accordance with the information.

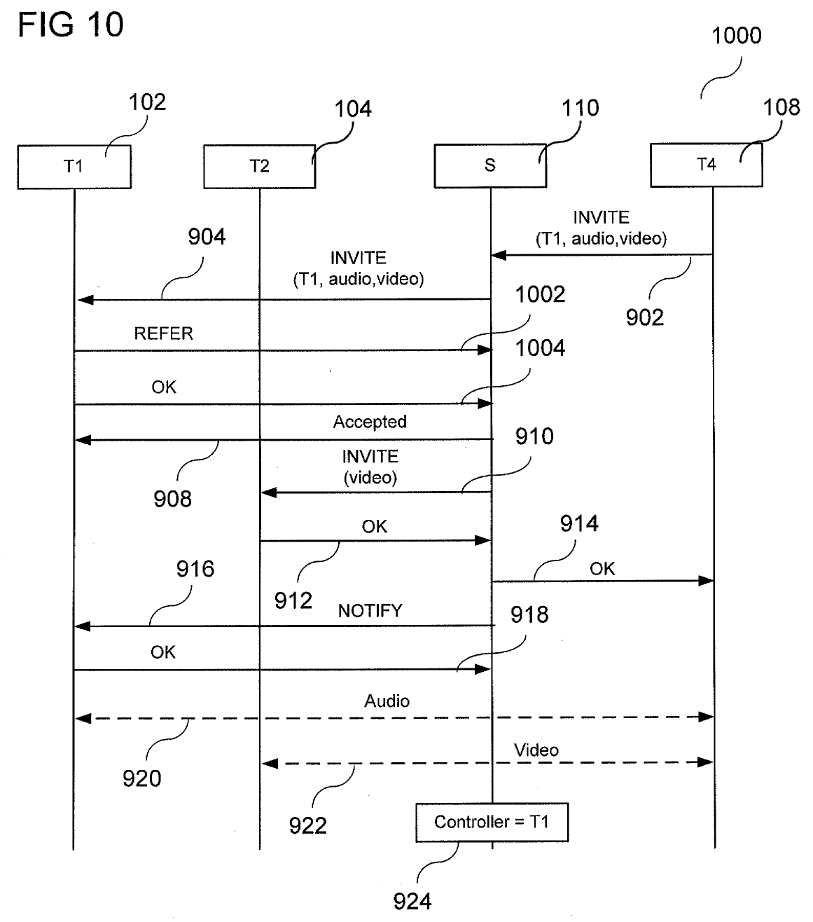

FIG. 11 shows a flow diagram 1100 illustrating a method for managing a collaborative communications session. In 1102, a message (for example a SIP INVITE message) including an invitation to a not yet existing communication session may be received. In 1104, a message (for example a SIP REFER message) including information for initiating a collaborative communications session in the not yet existing communication session may be sent before sending a message (for example a SIP OK message) including information indicating that the invitation is accepted. According to various embodiments, the method illustrated in FIG. 11 may be performed by an end device, and the messages may be received from or sent to a call managing server. Furthermore, the method illustrated in FIG. 11 will be explained in more detail with reference to FIG. 10 below.

According to various embodiments, a method for managing a collaborative communications session may be provided. The method may include sending a message (for example a SIP INVITE message) including an invitation to a not yet existing communication session, and receiving a message (for example a SIP REFER message) including information for initiating a collaborative communications session in the not yet existing communication session before a message (for example a SIP OK message) including information indicating that the invitation is accepted is received. According to various embodiments, the method may be performed by a call managing server, and the messages may be sent to or received from an end device. The method will be explained in more detail with reference to FIG. 10 below.

According to various embodiments, an end device may be provided. The end device may include a message receiving circuit configured to receive, for example from a call managing server, a message (for example a SIP INVITE message) including an invitation to a not yet existing communication session and a message generation circuit configured to generate a message (for example a SIP REFER message) including information for initiating a collaborative communications session in the not yet existing communication session, and the end device may further include a sender circuit configured to send the generated message, for example to a call managing server, before sending, for example to a call managing server, a message (for example a SIP OK message) including information indicating that the invitation is accepted. The end device will be explained in more detail with reference to FIG. 10 below.

According to various embodiments, a call managing server may be provided. The call managing server may include a sender circuit configured to send, for example to an end device, a message (for example a SIP INVITE message) including an invitation to a not yet existing communication session, and a receiver circuit configured to receive, for example from the end device, a message (for example a SIP REFER message) including information for initiating a collaborative communications session in the not yet existing communication session, before a message (for example a SIP OK message) including information indicating that the invitation is accepted is received (for example from an end device), and the call managing server may further include a manager circuit configured to initiate a collaborative communications session in a not yet existing communication session in accordance to the received information. The call managing server will be explained in more detail with reference to FIG. 10 below.

According to various embodiments, a computer program product may be provided, which may include a program, which, in case it is executed by a computer, may perform one of the methods described above.

According to various embodiments, devices and methods for collaborative communications sessions may be provided.

A collaborative session may be a peer's communications session that may include multiple communication devices. In other words, the communication peer may be using multiple communication devices to communicate with other peers. One or several of the devices may be controlling the collaborative session. Those controller devices may be able to direct media (e.g. audio, video, text, etc.) to the collaborative session's devices.

According to various embodiments, devices and methods may be provided that may allow establishing and setting up a collaborative session during the initiation of a communications session with a remote peer.

According to various embodiments, in the IP Multimedia Subsystem (IMS) collaborative sessions may be setup and used.

According to various embodiments, in IMS collaborative sessions, a single user may register multiple devices for communications. A collaborative session may be established when one of the multiple devices requests to transfer one or several of its media to another device registered by the user. After the transfer the requesting device may not be receiving the media anymore. Instead the other device may be receiving the media.

According to various embodiments, in IMS collaborative sessions, the transferring device may automatically become the collaborative session's controlling device. IMS collaborative sessions may have only one controlling device. According to various embodiments, multiple controlling devices may be set up and managed within collaborative sessions.

According to various embodiments, IMS collaborative sessions may be based on the Session Initiation Protocol (SIP).

According to various embodiments, SIP REFER messages may be used to request SIP messages to be sent by other devices. According to various embodiments, in IMS collaborative sessions, SIP REFER messages may be used to transfer media from a given device to another device (which may be understood as changing at least one end device in an existing communication of a pre-determined media between at least two end devices).

According to various embodiments, SIP request and response messages may contain the media feature tag “+g.3gpp.iut-controller” in their Contact header field, to indicate that the device identified by the Contact header field is controlling the collaborative session (in other words: is controller UE (User Equipment)).

According to various embodiments, in SIP messages, media may be described in the message's body according to the Session Description Protocol (SDP).

According to various embodiments, when initiating a communications session with a remote device by sending a corresponding SIP INVITE message, the initiating device may include SDP for other devices of the same user. Thereby a collaborative session may be established with the initiating device becoming the controller and the other devices becoming controllee devices of the collaborative session.

According to various embodiments, SIP INVITE messages may be used to initiate a communications session with a remote device and in the INVITE's body, a SIP message for establishing a collaborative session may be included.

According to various embodiments, the included SIP message may be a SIP REFER message specifying the media transfer to a controllee device of the collaborative session.

According to various embodiments, the response to the INVITE message may include a SIP response to the SIP message included in the INVITE message. According to various embodiments, the included response may be a SIP 202 Accepted message in response to an included SIP REFER message.

According to various embodiments, the initiating device may be implicitly subscribed to the REFER event package if the initiating SIP INVITE message includes a SIP REFER message.

According to various embodiments, the SIP INVITE message may include multiple SIP messages for specifying multiple controllee devices for the collaborative session.

According to various embodiments, the SIP INVITE message may include information in its body for specifying multiple controller devices. According to various embodiments, the included information may be specified by further included SIP messages.

According to various embodiments, collaborative sessions may be established when the device wanting to establish the collaborative session is not yet in a communications session with the remote device.

According to various embodiments, controllee devices may be specified if only their SIP addresses are known by the device wanting to establish the collaborative session.

According to various embodiments, currently existing protocols may not be desired to be extended for usage in accordance with various embodiments.

According to various embodiments, SDP c-lines reserved for transport layer addresses may not be desired to carry application layer SIP addresses.

According to various embodiments, the SDP implementation being used may not be desired to be extended compared to existing SDP implementations.

According to various embodiments, collaborative sessions with multiple controller devices may be established during communications initiation.

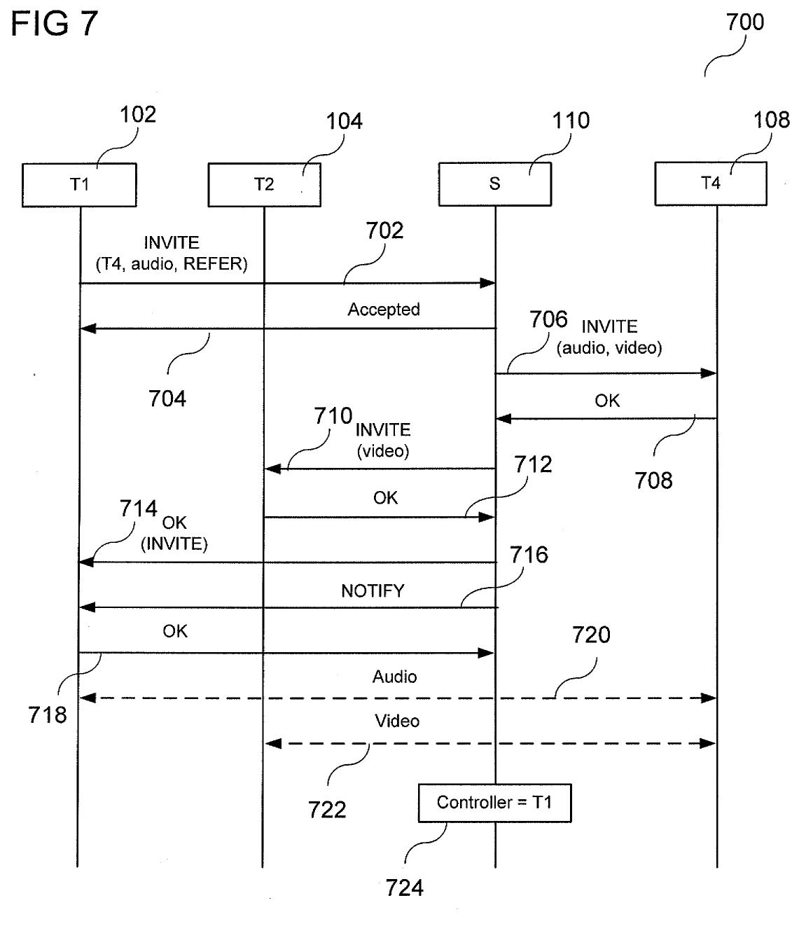

FIG. 7 shows a signaling flow diagram 700 illustrating a signaling flow in accordance with an embodiment. For the description of the signaling flow diagram 700, an arrangement 100 of devices like described with reference to FIG. 1 may be assumed, and the same reference signs may be used for the same devices.

For example, an IMS based communications system may be considered.

The system may include end devices and servers. The end devices may be connected to the servers. For better readability, all relevant servers may be subsumed in a single IMS server entity. However, it will be understood that the IMS may include several servers (like e.g. Call Session Control Function Server, Application Server, etc.). According to various embodiments, for session control, the Session Initiation Protocol (SIP) may be used.

For example, three end devices (the first end device 102 (T1), the second end device 104 (T2) and the third end device 106 (T3)) may belong to the first user U1, and another end device (the fourth end device 108 (T4)) may belong to the second user U2. All end devices may be connected to the call managing server 110 (S), for example an IMS server, and may be registered at the server 110.

For example, it may be assumed that the first user U1 wishes to communicate with the second user U2 with audio media on his device T1 (the first end device 102) and with video media on his device T2 (the second end device 104). In this example, it may further be assumed that U1 wishes to control media distribution to his devices by using end device T1 (the first end device 102). According to various embodiments, the first end device 102 (T1) may send a first message, for example a SIP INVITE message 702, to the call managing server, for example IMS Server 110, wherein the SIP INVITE message 702 may include a multipart body. The first part may include or may consist of SDP information for initiating the audio communications between the first end device 102 (T1) and device T4 (the fourth end device 108) of user U2. The second part may include or may consist of a SIP REFER message for initiating the video communications between the second device T2 (the second end device 104) of the first user U1 and device T4 of the second user U2.

According to various embodiments, the SIP INVITE message 702 may be as follows:

| | |
|---|---|
| Request-URI | T4 |

SIP HEADERS
To:T4

| | |
|---|---|
| From: | T1 |
| Call-ID: | a84b4c76e66710 |
| Contact: | T1 |

| | |
|---|---|
| Content-Length: | 3212 |
| Content-Type: | multipart/mixed; boundary=boundary42 |

CONTENT
--boundary42
Content-Type: application/sdp
v=0
o=U1 2890844526 2890844526 IN IP4 U1.com
s=Audio
c=IN IP4 123.45.67.89
t=0 0
m=audio 49172 RTP/AVP 0
a=rtpmap:0 PCMU/8000
--boundary42
Content-Type: message/sip
REFER S SIP/2.0
Via:
To: S; tag= 24680
From: T1; tag=13579
Call-ID: a84b4c76e66710
CSeq: 93809824 REFER
Max-Forwards: 70
P-Preferred-Identity: T1
Refer-To:
<T2;body=m%3Dvideo%201009%20RTP%2FAVP%2098%2099>
Require: target-dialog
Target-dialog:
cb03a0s09a2sdfglkj321576;remote-tag=abcdef;local-tag=123456
Contact: <T1>
Referred-By: T1
Accept: message/sipfrag
Content-Length: 0
--boundary42-

In the above shown SIP INVITE message 702 for initiating a collaborative session, S may be the SIP address of the IMS server 110, T1 may be the SIP address of the first end device 102 (T1), T2 may be the SIP address of the second end device 104 (T2), and T4 may be the SIP address of the fourth end device 108 (T4). It is to be noted that in the above shown SIP INVITE message 702, not all SIP header fields may be shown, but SIP header fields relevant for various embodiments may be shown.

According to various embodiments, the included SIP REFER message (in other words: the SIP REFER message included in the SIP INVITE message 702) may specify that the IMS server 110 should send a SIP INVITE message 710 for initiating video communications to the second end device 104 (T2). According to various embodiments, the Request URI of the SIP REFER message may be set to the address of the IMS server 110 and the Refer-to header field may be set to the address of the second end device 104 (T2).

According to various embodiments, in order to indicate that the audio and video connections should belong to one and the same collaborative session, the Call-ID of the SIP INVITE message 702 and the Call-ID of the included SIP REFER message may be chosen to be the same.

According to various embodiments, the IMS server 110 may receive the SIP INVITE message 702 and may realize that the message body includes multiple parts. According to various embodiments, since the second part may include or may consist of a SIP REFER message with the same Call-ID as the SIP INVITE message 702, the IMS server 110 may know that a collaborative session should be established using the SDP information and the SIP REFER message included in the SIP INVITE message 702.

According to various embodiments, the IMS server 110 may send a SIP 202 Accepted message 704 back to the first end device 102 (T1) in response to the SIP REFER message included in the received SIP INVITE message 702.

According to various embodiments, the SIP REFER message may also trigger implicit registration of the first end device 102 T1 to the REFER event package. According to various embodiments, this may mean that the first end device 102 T1 will be notified about events that are related to the SIP REFER message.

According to various embodiments, then the IMS server 110 may send a SIP INVITE message 706 to the device T4 (the fourth end device 108) of the second user U2 in order to initiate the audio and video connections to T4. According to various embodiments, upon receiving T4's response (for example a SIP OK message 708), the IMS server 110 may send another SIP INVITE message 710 to U1's second device 104 (T2) in order to initiate the video connection with T2.

According to various embodiments, after successful video connection setup for T2 (for example after having received a SIP OK message 712 from the second end device 104), the IMS server 110 may notify device T1 (the first end device 102) of the first user U1 about the successful video connection setup. For example, the IMS server 110 may send a SIP NOTIFY message 716 to the first end device 102, and the first end device 102 may send a SIP OK message 718, and the IMS server 110 may send a SIP OK message 714 as the response to the SIP INVITE message 702. According to various embodiments, the notification may be triggered by the REFER event package that device T1 (the first end device 102) has been implicitly registered for.

According to various embodiments, after successful connection setup, the IMS server 110 may maintain a collaborative session for user U1 consisting of controller device T1 and controllee device T2, like indicated by box 724. For example, audio may be interchanged between the first end device 102 (T1) of the first user U1 and the fourth end device 108 (T4) of the second user U2, like indicated by arrow 720, and video may be interchanged between the second end device 104 (T2) of the first user U1 and the fourth end device 108 (T4) of the second user U2, like indicated by arrow 722.

It is to be noted that in the signaling flow 700, not all SIP messages may be shown, but SIP messages relevant for various embodiments may be shown.

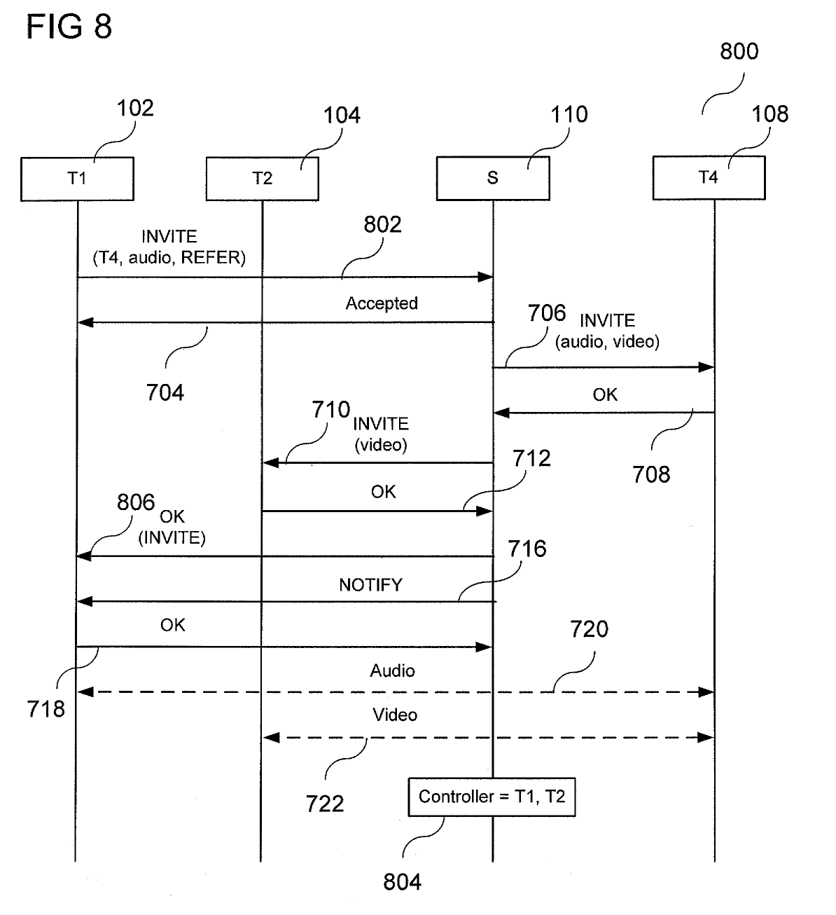

FIG. 8 shows a signaling flow diagram 800 illustrating a signaling flow in accordance with an embodiment. For description of the signaling flow diagram 800, a similar arrangement may be considered like for the description of the signaling flow diagram 700 of FIG. 7, and the signaling flow diagram 800 may include various messages that may be similar or identical to messages shown in the signaling flow diagram 700 of FIG. 7; therefore, the same reference signs may be used and duplicate description may be omitted.

For example, like in example of FIG. 7, it may be assumed that the first user U1 may wish to communicate with the second user U2 with audio media on his device T1 (the first end device 102) and with video media on his device T2 (the second end device 104). Furthermore, it may be assumed in this example, that the first user U1 wishes to control media distribution to his devices by using the first end device 102 (T1) or the second end device 104 (T2).

According to various embodiments, the procedure for this example may be the same as for the example of FIG. 7, except that a SIP INVITE message 802 for establishing the collaborative session now includes information on controller devices. According to various embodiments, the SIP INVITE message 802 may include a multipart body. According to various embodiments, the first part may include or may consist of SDP information for initiating the audio communications between T1 (the first end device 102, for example of the first user U1) and device T4 (the fourth end device 108) of the second user U2. According to various embodiments, the second part may include or may consist of a SIP REFER message for initiating the video communications between the second device T2 (the second end device 104) of the first user U1 and device T4 (the fourth end device 108) of the second user U2. According to various embodiments, in this example, the Contact header field of the SIP INVITE message 802 and the Refer-to header field of the included SIP REFER message (in other words: of the SIP REFER message included in the SIP INVITE message 802) may now include an additional “+g.3gpp.iut-controller” media feature tag. According to various embodiments, this tag may indicate that the first end device 102 (T1) and the second end device 104 (T2) both may be requested to become controlling devices.

According to various embodiments, the corresponding SIP INVITE message 802 may be as follows:

| | |
|---|---|
| Request-URI | T4 |

| SIP HEADERS | |
|---|---|
| To: | T4 |
| From: | T1 |
| Call-ID: | a84b4c76e66710 |
| Contact: | T1;+g.3gpp.iut-controller |

| | |
|---|---|
| Content-Length: | 3212 |
| Content-Type: | multipart/mixed; boundary=boundary42 |

CONTENT
--boundary42
Content-Type: application/sdp
v=0
o=U1 2890844526 2890844526 IN IP4 U1.com
s=Audio
c=IN IP4 123.45.67.89
t=0 0
m=audio 49172 RTP/AVP 0
a=rtpmap:0 PCMU/8000
--boundary42
Content-Type: message/sip
REFER S SIP/2.0
Via:
To: S; tag= 24680
From: T1; tag=13579
Call-ID: a84b4c76e66710
CSeq: 93809824 REFER
Max-Forwards: 70
P-Preferred-Identity: T1
Refer-To:
<T2;body=%3Dvideo%201009%20RTP%2FAVP%2098%2099>;+g.3gpp.iut-

controller

Require: target-dialog
Target-dialog: cb03a0s09a2sdfglkj321576;remote-tag=abcdef;local-tag=123456
Contact: <T1>;+g.3gpp.iut-controller
Referred-By: T1
Accept: message/sipfrag
Content-Length: 0
--boundary42-

It is to be noted that in the above shown SIP INVITE message 802 for initiating a collaborative session controlled by two devices and in the signaling flow 800 for establishing a two controller collaborative session during connection initiation, S may be the SIP address of IMS server 110, T1 may be the SIP address of the first end device 102 (T1), T2 may be the SIP address of the second end device 104 (T2), and T4 may be the SIP address of the fourth end device 108 (T4), and that not all SIP header fields may be shown, but SIP header fields relevant for the embodiment may be shown. In response to the SIP INVITE message 802, a SIP OK message 806 may be sent.

According to various embodiments, after successful connection setup, the IMS server 102 may maintain a collaborative session for the first user U1, this time including or consisting of the two controller devices T1 and T2, like indicated by box 804.

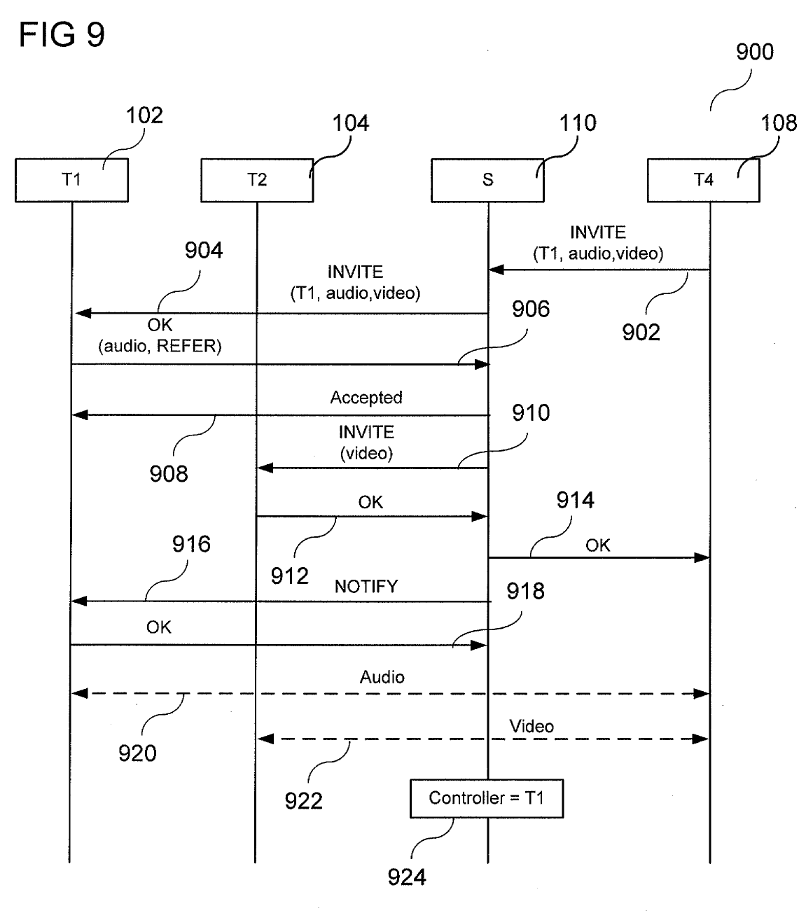

FIG. 9 shows a signaling flow diagram 900 illustrating a signaling flow in accordance with an embodiment. For this example, again the communications system like shown in the arrangement 100 of FIG. 1 may be assumed.

Furthermore, in this example, it may be assumed that the second user U2 may initiate a connection with the first end device 102 (T1) of the first user U1. The fourth end device 108 (T4) of the second user U2 may initiate an audio and video connection by sending a corresponding SIP INVITE message (902, 904) to the first device T1 of user U1, for example via the call managing server 110. For example, the first user U1 may decide to establish a collaborative session for the connection. According to various embodiments, the first end device T1 may accept the connection by sending a SIP 200 OK message 906 back to the server 110. According to various embodiments, the SIP 200 OK message 906 may include SDP for setting up the audio connection with the first end device 102 (T1). According to various embodiments, the SIP 200 OK message 906 may include a SIP REFER message for setting up the video connection with the second device 104 (T2) of the first user U1.

According to various embodiments, the SIP 200 OK message 906 may be as follows:

| | |
|---|---|
| Request-URI | T4 |

SIP HEADERS

| | |
|---|---|
| To: | T1 |
| From: | T4 |
| Call-ID: | a84b4c76e66710 |
| Contact: | T1 |

| | |
|---|---|
| Content-Length: | 3212 |
| Content-Type: | multipart/mixed; boundary=boundary42 |

CONTENT
--boundary42
Content-Type: application/sdp
v=0
o=U1 2890844526 2890844526 IN IP4 U1.com
s=Audio
c=IN IP4 123.45.67.89
t=0 0
m=audio 49172 RTP/AVP 0
a=rtpmap:0 PCMU/8000
--boundary42
Content-Type: message/sip
REFER S SIP/2.0
Via:
To: S; tag= 24680
From: T1; tag=13579
Call-ID: a84b4c76e66710
CSeq: 93809824 REFER
Max-Forwards: 70
P-Preferred-Identity: T1
Refer-To:
<T2;body=m%3Dvideo%201009%20RTP%2FAVP%2098%2099>
Require: target-dialog
Target-dialog:
cb03a0s09a2sdfglkj321576;remote-tag=abcdef;local-tag=123456
Contact: <T1>
Referred-By: T1
Accept: message/sipfrag
Content-Length: 0
--boundary42-

It is to be noted that in the above shown SIP 200 OK message 906 for initiating a collaborative session during connection initiation by a remote device and in the signaling flow 900 for establishing a collaborative session during connection initiation by a remote device, S may be the SIP address of IMS server 110, T1 may be the SIP address of the first end device 102 (T1), T2 may be the SIP address of the second end device 104 (T2), and T4 may be the SIP address of the fourth end device 108 (T4), and that not all SIP header fields may be shown, but SIP header fields relevant for the embodiment may be shown.

According to various embodiments, when receiving the SIP 200 OK message 906, the server 110 may send an accepted message 908 to the first end device 102, and may send a SIP INVITE message 910 to the second end device 104 (T2) of the first user U1 according to the SIP REFER message included in the received SIP 200 OK message 906.

According to various embodiments, upon receiving a SIP 200 OK response message 912 from the second end device 104 (T2), the server 110 may send back a SIP 200 OK message 914 to the remote device T4 (the fourth end device 108) of the second user U2 for setting up the audio and video connections with the fourth end device 108 (T4) according to the received SDP responses of the first end device 102 (T1) and the second end device 104 (T2).

According to various embodiments, like depicted in the signaling flow 900, the server 110 may send a SIP NOTIFY message 916 to the first end device 916, which may respond with a SIP OK message 918.

According to various embodiments, after successful connection setup, the IMS server 110 may maintain a collaborative session for user U1 consisting of controller device T1 and controllee device T2, like indicated by box 924. For example, audio may be interchanged between the first end device 102 (T1) of the first user U1 and the fourth end device 108 (T4) of the second user U2, like indicated by arrow 920, and video may be interchanged between the second end device 104 (T2) of the first user U1 and the fourth end device 108 (T4) of the second user U2, like indicated by arrow 922.

FIG. 10 shows a signaling flow diagram 1000 illustrating a signaling flow in accordance with an embodiment. For description of the signaling flow diagram 1000, a similar arrangement may be considered like for the description of the signaling flow diagram 900 of FIG. 9, and the signaling flow diagram 1000 may include various messages that may be similar or identical to messages shown in the signaling flow diagram 900 of FIG. 9; therefore, the same reference signs may be used and duplicate description may be omitted.

For example, when establishing a collaborative session during connection initiation by a remote device, instead of sending back a SIP 200 OK message 904 with a SIP REFER message included in the SIP 200 OK body, the controller device may send back a SIP REFER message 1002 and separately a SIP 200 OK message 1004 to the server. In this case the controller device may send back the SIP REFER message 1002 before sending back the SIP 200 OK message 1004. This may enable the server 110 before sending a response to the remote device, to realize that a collaborative session should be established. The server then may first send a SIP INVITE message 910 to the second end device 1004 (T2) of the first user U1 for initiating the connection with T2 and may wait for the response. Only after receiving the response, the server 110 may send a response to the remote device with included SDP according to the received SDP from the first end device 1002 (T1) and the second end device 1004 (T2).

It is to be noted that in the signaling flow 1000 for establishing a collaborative session during connection initiation by a remote device using a separate SIP REFER message, S may be the SIP address of an IMS server, T1 may be the SIP address of a first end device T1, T2 may be the SIP address of a second end device T2, and T4 may be the SIP address of a fourth end device T4.

According to various embodiments, devices and methods may be provided for collaborative sessions including or consisting of more than two devices.

According to various embodiments, devices and methods may be provided for collaborative sessions that include or consist of devices belonging to multiple users (in other words: to multiple subscribers).

According to various embodiments, instead of sending a SIP 202 Accepted response back to the collaborative session requesting device, no SIP 202 Accepted response may be sent back.

According to various embodiments, the SIP 202 Accepted message may be sent back to the collaborative session requesting device in the SIP 200 OK message body sent back from the IMS server to the requesting device. For example, a 200 OK message may be as follows:

| | |
|---|---|
| Request-URI | T4 |

| SIP HEADERS | |
|---|---|
| To: | S |
| From: | T1 |
| Call-ID: | a84b4c76e66710 |
| Contact: | S |

| | |
|---|---|
| Content-Length: | 212 |
| Content-Type: | multipart/mixed; boundary=boundary42 |

CONTENT
--boundary42
Content-Type: application/sdp
v=0
o=U1 2890844526 2890844526 IN IP4 U1.com
s=Audio
c=IN IP4 123.45.67.89
t=0 0
m=audio 49172 RTP/AVP 0
a=rtpmap:0 PCMU/8000
--boundary42
Content-Type: message/sip
SIP/2.0 202 Accepted
Via:
To: S; tag= 24680
From: T1; tag=13579
Call-ID: a84b4c76e66710
CSeq: 93809824 REFER
Contact: <S>
Content-Length: 0
--boundary42-

It is to be noted that in the above shown SIP 200 OK message including a SIP 202 Accepted message, S may be the SIP address of an IMS server, T1 may be the SIP address of a first end device T1, T2 may be the SIP address of a second end device T2, and T4 may be the SIP address of a fourth end device T4, and that not all SIP header fields may be shown, but SIP header fields relevant for various embodiments may be shown.

According to various embodiments, the collaborative session requesting device may not be implicitly registered to the REFER event package when receiving a SIP INVITE message with a SIP REFER message included in its multipart body. In this case successful connection setup due to the SIP REFER message may be indicated by the SIP 200 OK message sent back to the collaborative session requesting device.

According to various embodiments, multiple controllee devices may be specified in the collaborative session initiating SIP INVITE message by including multiple SIP REFER messages in the SIP INVITE message. In this case the included SIP REFER messages may be responded to by multiple or single SIP 202 Accepted responses sent back to the collaborative session initiating device.

According to various embodiments, instead of indicating multiple controllers by media feature tags, multiple controllers may be indicated by including a URI list or reference to a URI list of controller device addresses in the multipart body of the collaborative session initiating SIP INVITE message. For example, a SIP INVITE message may be as follows:

| | |
|---|---|
| Request-URI | T4 |

SIP HEADERS

| | |
|---|---|
| To: | T4 |
| From: | T1 |
| Call-ID: | a84b4c76e66710 |
| Contact: | T1 |

| | |
|---|---|
| Content-Length: | 3212 |
| Content-Type: | multipart/mixed; boundary=boundary42 |

CONTENT
--boundary42
Content-Type: application/sdp
v=0
o=U1 2890844526 2890844526 IN IP4 U1.com
s=Audio
c=IN IP4 123.45.67.89
t=0 0
m=audio 49172 RTP/AVP 0
a=rtpmap:0 PCMU/8000
--boundary42
Content-Type: message/sip
REFER S SIP/2.0
Via:
To: S; tag= 24680
From: T1; tag=13579
Call-ID: a84b4c76e66710
CSeq: 93809824 REFER
Max-Forwards: 70
P-Preferred-Identity: T1
Refer-To: <T2;body=m%3Dvideo%201009%20RTP%2FAVP%2098%2099>
Require: target-dialog
Target-dialog: cb03a0s09a2sdfglkj321576;remote-tag=abcdef;local-tag=123456
Contact: <T1>
Referred-By: T1
Accept: message/sipfrag
Content-Length: 0
--boundary42-
Content-Type: application/resource-lists+xml
<?xml version=“1.0” encoding=“UTF-8”?>

<resource-lists xmlns=“urn:ietf:params:xml:ns:resource-lists”

xmlns:xsi=“http://www.w3.org/2001/XMLSchema-instance”>

<list>

<entry uri=T1/>
<entry uri=T2/>

</list>

</resource-lists>

--boundary42-

It is to be noted that in the above described SIP INVITE message for initiating a collaborative session controlled by two devices specified by a URI list, S may be the SIP address of an IMS server, T1 may be the SIP address of a first end device T1, T2 may be the SIP address of a second end device T2, and T4 may be the SIP address of a fourth end device T4, and that not all SIP header fields may be shown, but SIP header fields relevant for the embodiment may be shown.

According to various embodiments, controller devices may alternatively be indicated in the collaborative session initiating SIP INVITE message's multipart body by SIP REFER messages for controller assignment. In this case the included SIP REFER messages for controller assignment may be specified according to one of commonly used ways.

According to various embodiments, controller devices may alternatively be indicated in the collaborative session initiating SIP INVITE message's multipart body by SIP INFO messages for controller assignment. In this case the included SIP INFO messages may be specified according to one of commonly used ways.

An example SIP INVITE message may be as follows:

| | |
|---|---|
| Request-URI | T4 |

SIP HEADERS

| | |
|---|---|
| To: | T4 |
| From: | T1 |
| Call-ID: | a84b4c76e66710 |
| Contact: | T1 |

| | |
|---|---|
| Content-Length: | 3212 |
| Content-Type: | multipart/mixed; boundary=boundary42 |

CONTENT
--boundary42
Content-Type: application/sdp
v=0
o=U1 2890844526 2890844526 IN IP4 U1.com
s=Audio
c=IN IP4 123.45.67.89
t=0 0
m=audio 49172 RTP/AVP 0
a=rtpmap:0 PCMU/8000
--boundary42
Content-Type: message/sip
REFER S SIP/2.0
Via:
To: S; tag= 24680
From: T1; tag=13579
Call-ID: a84b4c76e66710
CSeq: 93809824 REFER
Max-Forwards: 70
P-Preferred-Identity: T1
Refer-To: <T2;body=m%3Dvideo%201009%20RTP%2FAVP%2098%2099>
Require: target-dialog
Target-dialog: cb03a0s09a2sdfglkj321576;remote-tag=abcdef;local-tag=123456
Contact: <T1>
Referred-By: T1
Accept: message/sipfrag
Content-Length: 0
--boundary42-
Content-Type: message/sip
INFO S SIP/2.0
To: S; tag= 24680
From: T1; tag=13579
Call-ID: a84b4c76e66710
CSeq: 76234724 INFO

| | |
|---|---|
| Contact: | T1 |

| | |
|---|---|
| Content-Length: | 262 |
| Content-Type: | application/resource-lists+xml |

| | |
|---|---|
| Content: | <?xml version=″1.0″ encoding=″UTF-8″?> |

<resource-lists xmlns=″urn:ietf:params:xml:ns:resource-lists″

xmlns:xsi=″http://www.w3.org/2001/XMLSchema-instance″>

<list>

<entry uri=″sip:T1″/>

<feature-tag>g.3gpp.iut-controller</feature-tag>

<entry uri=″sip:T2”>

<feature-tag>g.3gpp.iut-controller</feature-tag>

</entry>

</list>

</resource-lists>

--boundary42-

It is to be noted that in the above shown SIP INVITE message for initiating a collaborative session controlled by two devices specified by SIP INFO, S may be the SIP address of IMS server 110, T1 may be the SIP address of the first end device 102 (T1), T2 may be the SIP address of the second end device 104 (T2), and T4 may be the SIP address of the fourth end device 108 (T4), and that not all SIP header fields may be shown, but SIP header fields relevant for the embodiment may be shown.

According to various embodiments, the collaborative session requesting device may not become controller by indicating controllers according to the above mechanisms without specifying the requesting device to become controller.

According to various embodiments, the requesting device may always become controller device regardless whether it has been explicitly specified to become controller device or not.

According to various embodiments, device and methods may be provided for use in communications systems that are not based on the IMS.

According to various embodiments, device and methods may be provided for use during connection modification for adding media to controllee devices within an existing collaborative session. In this case also a SIP INVITE message including other SIP messages may be sent to the IMS server, but the SIP INVITE message may not establish a new collaborative session; instead the SIP INVITE message may modify existing connections within the collaborative session and add new media to controllee devices. According to various embodiments, the added media may be specified by SIP messages included in the SIP INVITE message, e.g. by SIP REFER messages.

According to various embodiments, devices and methods may be provided for use for modifying multiple connections of multiple devices within an existing collaborative session. In this case a SIP INVITE message including other SIP messages may be sent to the IMS server. According to various embodiments, the SDP included in the SIP INVITE message may modify the senders connections and the included SIP messages may modify the controllee devices’ connections.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for providing information for managing a collaborative communications session, the method comprising:
generating a first message according to a call control protocol;
generating a second message according to the call control protocol, the second message comprising information for managing the collaborative communications session; and
sending the first message to a call managing server;
wherein the first message is generated to include the second message.

2. The method of claim 1,
wherein the call control protocol comprises at least one protocol selected from a list of protocols consisting of:
Session Initiation Protocol SIP;
Real-Time Control Protocol RTCP;
Hyper Text Transport Protocol http;
File Transfer Protocol FTP;
Simple Mail Transfer Protocol SMTP; and
XML Configuration Access Protocol XCAP.

3. The method of claim 1,
wherein the second message comprises information for changing an existing communication session.

4. The method of claim 1,
wherein the second message comprises information for initiating a collaborative communications session in a not yet existing communication session.

5. The method of claim 1,
wherein the second message is at least one of a SIP REFER message and a SIP INFO message.

6. The method of claim 1,
wherein the first message comprises information for managing a communication session.

7. The method of claim 1,
wherein a call identifier of the first message and a call identifier of the second message are the same.

8. A method for managing a collaborative communications session, the method comprising:
receiving a first message according to a call control protocol;
determining whether the first message includes a second message according to the call control protocol comprising information for managing the collaborative communications session; and
in case it is determined that the first message includes a second message according to the call control protocol comprising information for managing the collaborative communications session, managing the collaborative communications session in accordance with the information.

9. The method of claim 8,
wherein the second message comprises information for initiating a collaborative communications session from an existing communication session.

10. The method of claim 8,
wherein the second message comprises information for initiating a collaborative communications session in a not yet existing communication session.

11. The method of claim 8,
wherein the second message is at least one of a SIP REFER message and a SIP INFO message.

12. The method of claim 8,
wherein the first message comprises information for managing a communication session.

13. An end device for providing information for managing a collaborative communications session, the end device comprising:
a first generation circuit configured to generate a first message according to a call control protocol;
a second generation circuit configured to generate a second message according to the call control protocol, the second message comprising information for managing the collaborative communications session; and
a sender circuit configured to send the first message to a call managing server;
wherein the first generation circuit is configured to generate the first message to include the second message.

14. The end device of claim 13,
wherein the call control protocol comprises at least one protocol selected from a list of protocols consisting of:
Session Initiation Protocol SIP;
Real-Time Control Protocol RTCP;
Hyper Text Transport Protocol http;
File Transfer Protocol FTP;
Simple Mail Transfer Protocol SMTP; and
XML Configuration Access Protocol XCAP.

15. The end device of claim 13,
wherein the second generation circuit is configured to generate the second message comprising information for changing an existing communication session.

16. The end device of claim 15,
wherein the second generation circuit is configured to generate the second message comprising information for initiating a collaborative communications session in a not yet existing communication session.

17. The end device of claim 13,
wherein the second generation circuit is configured to generate the second message as at least one of a SIP REFER message and a SIP INFO message.

18. The end device of claim 13,
wherein the first generation circuit is configured to generate the first message comprising information for managing a communication session.

19. The end device of claim 13,
wherein the first generation circuit and the second generation circuit are configured to generate the first message and the second message with a call identifier of the first message and a call identifier of the second message being the same.

20. A call managing server for managing a collaborative communications session, the call managing server comprising:
a receiver circuit configured to receive a first message according to a call control protocol;
a determination circuit configured to determine whether the first message includes a second message according to the call control protocol comprising information for managing the collaborative communications session; and
a manager circuit configured to, in case the determination circuit determines that the first message includes a second message according to the call control protocol comprising information for managing the collaborative communications session, manage the collaborative communications session in accordance with the information.

21. The call managing server of claim 20,
wherein the second message comprises information for initiating a collaborative communications session from an existing communication session.

22. The call managing server of claim 20,
wherein the second message comprises information for initiating a collaborative communications session in a not yet existing communication session.

23. The call managing server of claim 20,
wherein the second message is at least one of a SIP REFER message and a SIP INFO message.

24. The call managing server of claim 20,
wherein the first message comprises information for managing a communication session.

25. A method for managing a collaborative communications session, the method comprising:
receiving a message comprising an invitation to a not yet existing communication session; and
sending a message comprising information for initiating a collaborative communications session in the not yet existing communication session before sending an accepting message comprising information indicating that the invitation is accepted.
